(19) United States
(12) Patent Application Publication
(10) Pub. No.: US 2008/0042041 A1
(43) Pub. Date: Feb. 21, 2008

(54) Computer input device with resolution control

(76) Inventors: Chiang S. Cheah, Penang (MY); Akihiro Machida, Sunnyvale, CA (US); Chiang M. Teo, Melaka (MY)

Correspondence Address: Kathy Manke;Avago Technologies Limited, 4380 Ziegler Road, Fort Collins, CO, 80525, US

(21) Appl. No.: 11/502,208

(22) Filed: Aug. 10, 2006

(51) Int. Cl. G01J 1/20

(52) U.S. Cl. 250/201.1

(57) ABSTRACT

The present invention is directed to an optical pointer control having variable image resolution. In one embodiment, the pointer control includes a mechanism for adjusting the position of the lens or sensor relative to the navigation surface, and hence adjusting the image resolution. The mechanism for adjusting the position of the lens or sensor within the optical pointer control can include mechanical, electromechanical and electronic components to adjust the position of the lens and/or sensor relative to the navigation surface. The mechanism may be controlled via a microcontroller. The present invention is also directed to a method for allowing a user to control resolution of an optical mouse during operation. The lens and/or sensor position can be optimized, for example by an actuator, in response to a predetermined optical path.

### TECHNICAL FIELD

The present invention relates to user input devices for computer systems and more particularly to an optical pointer control device having resolution control.

### BACKGROUND OF THE INVENTION

Computer input devices, such as an optical pointer control (mouse), use digital imaging to determine changes in relative position of the pointer control. In such applications, a light source illuminates the navigation surface beneath the pointer control and a lens focuses an image of the navigation surface onto an optical sensor, such as a CMOS sensor. The optical pointer control detects motion by acquiring a series of images of the navigation surface as it passes under the lens. These images are processed to determine a change in pointer control position from one image to the next. The relative position change of the pointer control can be determined by monitoring common features between successive images. The magnitude and direction of the position change can be determined and provided to the computer. A corresponding movement is generated on a computer display, for example, by movement of a cursor.

The optical path (surface-to-sensor) through a typical optical pointer control is essentially constant, as the position of the lens and optical sensor relative to the navigation surface is fixed. As a result, the resolution of the optical pointer control is also fixed and thus is unable to account for differences in “depth of field” of surfaces such as wood that have repetitive patterns. The optical pointer control will often track poorly on such surfaces as evidenced by erratic cursor behavior on the computer screen.

### BRIEF SUMMARY OF THE INVENTION

The present invention is directed to an optical pointer control having variable image resolution. In one embodiment, the pointer control includes a mechanism for adjusting the position of the lens or sensor relative to the navigation surface, and hence adjusting the image resolution.

The mechanism for adjusting the position of the lens or sensor within the optical pointer control can include mechanical, electromechanical and electronic components to adjust the position of the lens and/or sensor relative to the navigation surface. The mechanism may be controlled via a microcontroller.

The present invention is also directed to a method for allowing a user to control resolution of an optical mouse during operation. The lens and/or sensor position can be optimized, for example by an actuator, in response to a predetermined optical path.

The foregoing has outlined rather broadly the features and technical advantages of the present invention in order that the detailed description of the invention that follows may be better understood. Additional features and advantage of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following description taken in conjunction with the accompanying drawings, in which:

FIG. 1 is a cross-sectional view of one embodiment of an optical mouse having adjustable resolution;

FIG. 2 is an enlarged view of a portion of FIG. 1;

FIG. 3 is an illustration of an embodiment of an actuator; and

FIG. 4 is a diagram of a lens, sensor and navigation surface.

### DETAILED DESCRIPTION OF THE INVENTION

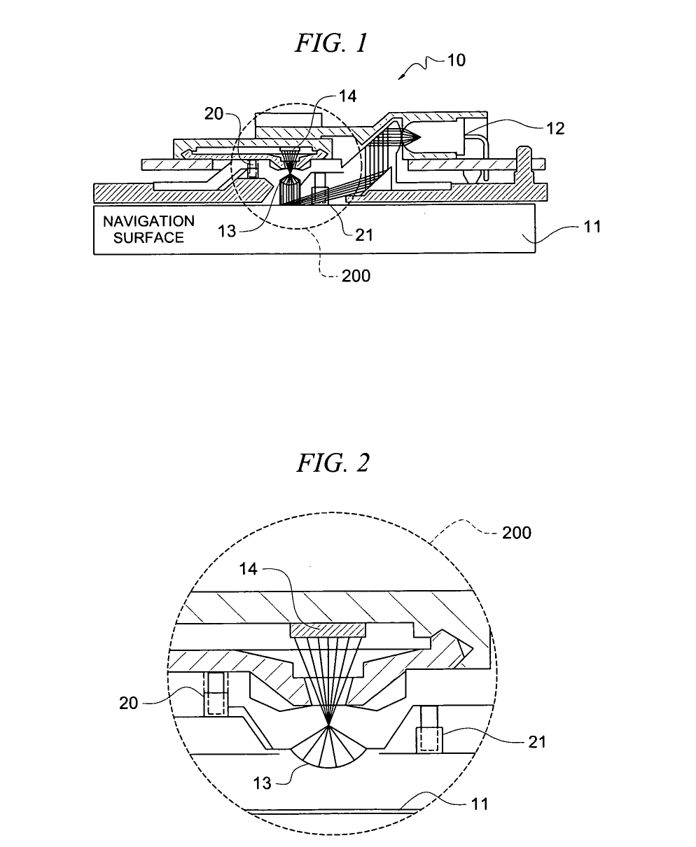

FIG. 1 shows a cross sectional view of optical mouse 10 situated upon navigation surface 11 and with an upper cover removed. Optical mouse 10 includes light emitting diode (LED) 12, imaging lens 13 and image sensor 14. The distance between lens 13 and image sensor 14 is referred to as the sensor distance, while the distance between lens 13 and the navigation surface 11 is referred to as the surface distance, as also shown in FIG. 4. In one embodiment, image resolution of optical mouse 10 can be adjusted by increasing or decreasing the sensor distance and/or surface distance. In one embodiment, the sensor distance and surface distance are independently controlled via a pair of actuators 20, 21, respectively. The sensor and lens positions can be optimized, for example via a controller, in order to provide a desired resolution level.

FIG. 2 is an illustration of portion 200 of optical mouse 10 showing actuator 20 positioned between lens 13 and image sensor 14 and actuator 21 positioned between lens 13 and navigation surface 11. Actuator 20 is used to vary the sensor distance, while actuator 21 is used to vary the surface distance. Actuators 20, 21 may be electromechanical devices or any type of device that can move or refocus the light rays. Actuators 20, 21 can include position sensors for motion control via, for example, an on-board microprocessor. One or more of each of these sensors can be provided and they both can be the same or different from each other.

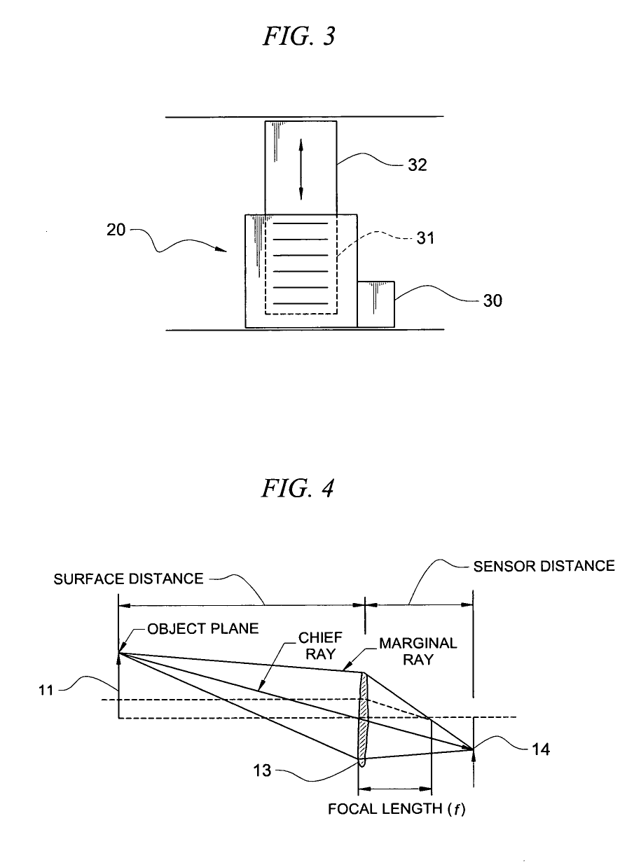

FIG. 3 is an illustration of actuator 20 having electric motor 30 which rotates threaded drive 31 in the well known fashion. Such a device is commonly referred to as a linear actuator. Rotation of threaded drive 31 causes expansion or contraction (upward or downward motion) of piston 32 and hence an increase or decrease in the sensor distance. Similarly, a second electric linear actuator may be used to adjust the surface distance. These electric linear actuators may be controlled, for example by a microcontroller (not shown), in response to a user's selection of a resolution level.

FIG. 4 illustrates lens 13, sensor 14 and navigation surface 11. The following relationship exists between the surface distance (Dsurface) and the sensor distance (Dsensor):

(1/f)=(1/Dsurface)+(1/Dsensor)

where f is the focal length of the lens. Magnification (M) is the ratio of the sensor distance to the sensor distance:

M=(Dsensor)/(Dsurface)

The image resolution (IR) is a function of M. For example:

IR=M×k, where k is a constant.

A microcontroller may be used to determine appropriate displacement of lens 13 or sensor 14 relative to navigation surface 11 in order to optimize image resolution. The microcontroller may activate actuator 20 and/or actuator 21 to increase or decrease the sensor distance and/or surface distance. The image resolution of optical mouse 10 can be communicated to the computer and displayed to the user. In another embodiment, the user can adjust the positioning of the lens and/or sensor via manipulation of, for example, a finger wheel in order to manually adjust optical resolution.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, process, machines, manufacture, compositions of matter, means, methods, or steps, presently existing or later to be developed that perform substantially the same results as the corresponding embodiments described herein may be utilized according to the present invention. Accordingly, the appended claims are intended to include within their scope such process, machines, manufacture, composition of matter, means, methods or steps.

What is claimed is:

1. An input device comprising:
an optical sensor;
a lens providing light information from a navigation surface to said optical sensor; and
an actuator for allowing one or more distances between said optical sensor, said lens and said navigation surface to be varied during use of said device.

2. The device of claim 1 wherein said actuator is adapted to vary the distance between said lens and navigation surface.

3. The device of claim 1 wherein said actuator is adapted to vary the distance between said lens and said optical sensor.

4. The device of claim 1 wherein said actuator is an electric linear actuator.

5. The device of claim 1 wherein position information is communicated to a microcontroller.

6. The device of claim 5 wherein said microcontroller controls movement of said actuator.

7. The device of claim 6 wherein position information correlates to lens position relative to said navigation surface.

8. The device of claim 6 wherein position information correlates to sensor position relative to said lens.

9. An optical mouse comprising:
a lens for directing light from a navigation surface to an optical sensor; and
means enabled, at least in part, from input received during use for adjusting a distance between said lens and navigation surface.

10. The optical mouse of claim 9 further comprising:
wherein said input is received from a user of said mouse.

11. The optical mouse of claim 9 further comprising:
a lens position sensor in communication with an electronic controller.

12. A method for controlling resolution of an optical mouse on a navigation surface during operation of said mouse, said method comprising:
determining a preferred optical path between said surface and an optical sensor; and
adjusting a distance between said surface and said optical sensor in accordance with said preferred optical path.

13. The method of claim 12 wherein said adjusting comprises adjusting a position of a lens relative to the navigation surface.

14. The method of claim 12 wherein said adjusting comprises adjusting a position of said optical sensor relative to the navigation surface.

15. The method of claim 12 wherein said adjusting comprises rotating a threaded element which lifts or lowers at least a portion of said optical mouse relative to said navigation surface.

16. The method of claim 13 wherein said determining utilizes a form of the equation:
(1/f)=(1/S₁)+(1/S₂)
where f is focal length, S₁ is said distance between said optical sensor and lens, and S₂ is said distance between said lens and navigation surface.

17. A method for controlling resolution of an optical mouse on a navigation surface during operation of said mouse, said method comprising:
determining a preferred positional relationship between said surface, a lens, and an optical sensor; and
adjusting the position of the lens or optical sensor or both relative to the navigation surface in accordance with a determined preferred positional relationship.

18. The method of claim 17 wherein said adjusting comprises rotating a threaded element which lifts or lowers at least a portion of said optical mouse relative to said navigation surface.

19. The method of claim 17 wherein said determining utilizes a form of the equation:
(1/f)=(1/S₁)+(1/S₂)
where f is focal length, S₁ is said distance between said optical sensor and lens, and S₂ is said distance between said lens and navigation surface.

20. The method of claim 17 wherein said determining is controlled by a user of said optical mouse.
